(19) United States
(12) Patent Application Publication
(10) Pub. No.: US 2019/0006667 A1
(43) Pub. Date: Jan. 3, 2019

(54) USE OF ELECTROCHEMICAL CELLS CONTAINING A LITHIATED TITANATE OXIDE NEGATIVE ACTIVE MATERIAL FOR LOW EARTH ORBIT APPLICATIONS

(71) Applicant: SAFT, Levallois-Perret (FR)

(72) Inventors: Kamen NECHEV, Cockeysville, MD (US); Yannick BORTHOMIEU, VOUNEUIL SOUS BIARD (FR); Chengsong MA, Lutherville Timonium, MD (US); Thomas GRESZLER, Phoenix, MD (US); Cecile TESSIER, Bruges (FR)

(73) Assignee: SAFT, Levallois-Perret (FR)

(21) Appl. No.: 16/062,977

(22) PCT Filed: Dec. 18, 2015
(86) PCT No.: PCT/IB2015/002559

§ 371 Date: Jun. 15, 2018

(51) Int. Cl. H01M 4/485; H01M 10/0525

(52) U.S. Cl. CPC H01M 4/485; H01M 4/505; H01M 10/0525

(57) ABSTRACT

A Low Earth Orbit (LEO) satellite has 95 to 105 minutes orbit time with only 60-65 minutes available for recharging. Due to the low charge capability of a Li-ion graphite cell, depth of discharge is limited for this application. The cell of the invention using a lithiated titanate oxide or a titanate oxide able to be lithiated in the negative electrode allows increase of depth of discharge. Increasing charge rate without amplifying capacity loss per cycle allows improvement of useful specific energy per cycle. Depth of discharge values up to 70-80% can be envisioned. Even if the cell exhibits low specific energy, the LEO application is a specific case where useful energy per cycle can be optimized to 70 to 80 Wh/kg.

### TECHNICAL FIELD

The invention pertains to the technical field of lithium-ion electrochemical cells used in satellites placed in low earth orbit.

### BACKGROUND OF THE INVENTION

The low earth orbit (LEO) is an orbit around Earth with an altitude between about 160 km and 2,000 km. The electrochemical cells of a satellite placed in low earth orbit are charged during periods of sunlight and discharged during periods of darkness to meet the satellite's power demand. In LEO applications, the time of charge of the electrochemical cells is thus imposed by the duration of the sunlight.

The majority of satellites placed in LEO make one complete revolution around the Earth in about 90 minutes. During this complete revolution, an electrochemical cell of the satellite undergoes one cycle of charge/discharge. The charging time can be as short as 60-65 minutes. This implies that the electrochemical cell should be capable of withstanding repeated charge and discharge cycles within a relatively short period of time and at high charge and discharge rates. Typically, a charge rate for which the cell is charged/discharged within one hour is sought. This means a charge/discharge rate of at least C, C being the nominal capacity of the cell.

Additionally, in LEO applications, an electrochemical cell is expected to last up to 12 years. Since, the cell undergoes about 15 cycles of charge/discharge per day, the LEO application requires that the cell be capable of undergoing about 5,300 charge/discharge cycles in a year, thus about 65,000 charge/discharge cycles over 12 years.

Electrochemical cells comprising graphite as negative active material and a lithiated oxide of nickel, cobalt and aluminum (NCA) as positive active material are known in the art. They operate at a mean voltage of 3.5 V and provide a relatively high energy density of at least about 150 Wh/kg. However, they cannot be charged at a high charge rate nor can they reach a high life cycle of 65,000 charge/discharge cycles over 12 years. Indeed, when a cell containing graphite in the negative electrode is partly or fully charged at a high current, some electrode areas are more solicited than others. As lithium diffusion in a graphite electrode is ten times less than in the positive electrode, lithium ion concentration tends to increase in the more solicited areas and to decrease in the less active ones. This induces a lithium distribution heterogeneity at the surface of the negative electrode, which eventually causes degradation of the negative electrode. Further, when such a cell is used under cycling conditions, a rapid loss of capacity is observed.

In order to avoid lithium distribution heterogeneity at the surface of the negative electrode, a moderate charge rate has to be applied, such as C/3 for a high rate capable graphite electrode. However, this low charge rate limits the depth of discharge of the cell to about 30%.

Therefore, there is a need for a lithium-ion electrochemical cell which would be capable of withstanding high charge/discharge rates, that is, rates of at least C/2, without experiencing a reduced loss of capacity when used in charge/discharge cycle conditions in comparison with an electrochemical cell containing graphite as the negative active material.

### SUMMARY OF THE INVENTION

To this end, the invention provides an electrochemical cell for use in a low earth orbit spacecraft, said electrochemical cell comprising a positive electrode and a negative electrode, said negative electrode comprising as an electrochemically active material a lithiated titanate oxide or a titanate oxide able to be lithiated. The spacecraft may be a satellite, in particular a communication and Earth or space observation satellite

According to one embodiment, the electrochemical cell is discharged at a depth of discharge of at least 50%, preferably at least 70%, most preferably 80%.

According to one embodiment, the electrochemical cell is charged at a current of at least C/2, preferably at least C, wherein C is the nominal capacity of the electrochemical cell.

According to one embodiment, the electrochemical cell undergoes at least 15 cycles of charge/discharge per day.

According to one embodiment, the lifetime of the electrochemical cell is up to 12 years.

According to one embodiment, the electrochemical cell is capable of undergoing at least about 65,000 cycles during its lifetime, preferably at least 70,000 cycles.

According to one embodiment, the lithiated titanate oxide or the titanate oxide able to be lithiated is selected from the group consisting of:
a) LiₐTi_{b}O₄ wherein 0.5≤a≤3 and 1≤b≤2.5
b) LiₓMg_{y}Ti_{z}O₄ wherein x>0; z>0; 0.01≤y≤0.20; 0.01≤y/z≤0.10 and 0.5≤(x+y)/z≤1.0
c) Li_{4+y}Ti_{5-d}M²_{d}O₁₂ wherein M² is at least one metal selected from the group consisting of Mg, Al, Si, Ti, Zn, Zr, Ca, W, Nb, and Sn, −1≤y≤3.5 and 0≤d≤0.1
d) H₂Ti₆O₁₃
e) H₂Ti₁₂O₂₅
f) TiO₂
g) LiₓTiNb_{y}O_{z} wherein 0≤x≤5; 1≤y≤24; 7≤z≤62
h) LiₐTiM_{b}Nb_{c}O_{7+σ}wherein0≤a≤5;0≤b≤0.3;0≤c≤10; −0.3≤σ≤0.3 and M is at least one element selected from Fe, V, Mo and Ta
i) Nb_{α}Ti_{β}O_{7+γ} wherein 0≤α≤24; 0≤β≤1; −0.3≤γ≤0.3
and mixtures thereof.

According to one embodiment, the positive electrode comprises an electrochemically active material selected from the group consisting of:
compound i) having the formula LiₓMn_{1-y-z}M′_{y}M″_{z}PO₄ (LMP), where M′ and M″ are different from one another and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
compound ii) having the formula LiₓM_{2-x-y-z-w}M′_{y}M″_{z}M′″_{w}O₂ (LMO2), where M, M′, M″ and M′″ are selected from the group consisting of B, Mg, Al, Si, Ca, Ti, V, Cr, Mn, Fe, Co, Ni, Cu, Zn, Y, Zr, Nb and Mo, provided that M
   or M′ or M″ or M′″ is selected from Mn, Co, Ni, or Fe;
   M, M′, M″ and M′″ being different from each other; with 0.8≤x≤1.4;
   0≤y≤0.5; 0≤z≤0.5; 0≤w≤0.2 and x+y+z+w<2;
compound iii) having the formula LiₓMn_{2-y-z}M′_{y}M″_{z}O₄ (LMO), where M′ and M″ are selected from the group consisting of B, Mg, Al, Si, Ca, Ti, V, Cr, Fe, Co, Ni, Cu, Zn, Y, Zr, Nb and Mo; M′ and M″ are different from each other, and 1≤x≤1.4; 0≤y≤0.6; 0≤z≤0.2;
compound iv) of formula LiₓFe_{1-y}M_{y}PO₄(LFMP), where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y=0.6;
compound v) of formula xLi₂MnO₃; (1-x)LiMO₂ where M is selected from Ni, Co and Mn and z≤1;
compound vi) of formula Li_{a+y}(M¹₍₁₋ₜ₎Moₜ)₂M²_{b}(O₁₋ₓF₂ₓ)_{c} wherein M¹ is selected from the group consisting of Ni, Mn, Co, Fe, V or a mixture thereof; M² is selected from the group consisting of B, Al, Si, P, Ti and Mo;
   with 4≤a≤6; 0<b≤1.8; 3.8≤c≤14; 0≤x<1; −0.5≤y≤0.5; 0≤t≤0.9;
   b/a<0.45;
   the coefficient c satisfying one of the following relationships:
   c=4+y/2+z+2t+1.5b if M² is selected from B and Al;
   c=4+y/2+z+2t+2b if M² is selected from Si, Ti and Mo;
   c=4+y/2+z+2t+2.5b if M² is P;
   with z=0 if M¹ is selected from Ni, Mn, Co and Fe; and z=1 if M¹ is V.
compound vii) of formula Li₄₊ₓMnM¹ₐM²_{b}O_{c} wherein:
   M¹ is selected from the group consisting in Ni, Mn, Co, Fe and a mixture thereof;
   M² is selected from the group consisting in Si, Ti, Mo, B, Al and a mixture thereof; with:
   −1.2≤x≤3; 0<a≤2.5; 0≤b≤1.5; 4.3≤c≤10; and
   c=4+a+n.b+x/2
   wherein:
   n=2 when M² is selected from the group consisting in Si, Ti, Mo or a mixture thereof; and
   n=1.5 when M² is selected from the group consisting in B, Al or a mixture thereof,
and a mixture of one or more of compounds i) to vii).

The formula of compound ii) may in particular fulfil the following requirements:

1≤x≤1.15;

M is Ni;

M′ is Co;

M″ is Al

y>0;

z>0;

w=0.

Preferably in compound ii), x=1; 0.62≤2x-y-z≤0.85; 0.10≤y≤0.25; 0.05≤z≤0.15.

In one preferred embodiment, compound ii) is LiNi_{0,8}Co_{0,15}Al_{0,05}O₂.

### BRIEF DESCRIPTION OF THE DRAWINGS

FIG. 1 shows the charge/discharge curves of two cells according to the invention at various charge/discharge rates.

FIG. 2 shows variation of impedance as a function of the number of cycles.

FIG. 3 shows variation of capacity loss as a function of the number of cycles.

FIG. 4 shows the percentage of retained capacity as a function of the number of cycles for a reference cell (C) and for cells according to the invention (D-K).

### DETAILED DESCRIPTION OF EMBODIMENTS

The Applicant has unexpectedly discovered that electrochemical cells containing a lithiated titanate oxide or a titanate oxide able to be lithiated (LTO) as negative electrochemically active material can be charged/discharged at a high current, thereby meeting the requirement of the LEO application. Indeed, the use of LTO as negative electrochemically active material allows a suppression of the heterogeneous distribution of lithium at the surface of the negative electrode when the cell is charged at a high current.

Since cells containing an LTO as the negative active material support a higher charging current, depth of discharge can be increased up to 50%, more preferably up to 70%, and most preferably up to 80%, which represents a significant improvement in comparison with the limit of 30% achievable when the negative active material is graphite.

This discovery is unexpected since it is known that electrochemical cells containing LTO as negative active material and a lithiated oxide of NCA as positive active material have an energy density of about 100 Wh/kg, which is low in comparison with the energy density of cells containing graphite as negative active material and NCA as positive active material, which is about 150 Wh/kg. Thus, although it would be disadvantageous in terms of energy density to use LTO as the negative active material in comparison with graphite, the use of LTO is advantageous in the context of the present invention, that is, when the cell is subjected to charging at a high rate. As a matter of fact, for LEO applications, a cell containing graphite as the negative active material and a lithiated oxide of NCA as the positive active material offers an effectively usable energy density of only about 45 Wh/kg instead of 70-80 Wh/kg reached by a cell the negative electrode of which contains LTO.

The lithiated titanate oxide or the titanate oxide able to be lithiated may be selected from the following oxides:
a) LiₐTi_{b}O₄ wherein 0.5≤a≤3 and 1≤b≤2.5, including Li₄Ti₅O₁₂, Li₂TiO₃, Li₂Ti₃O₇ and LiTi₂O₄
b) LiₓMg_{y}Ti_{z}O₄ wherein x>0; z>0; 0.01≤y≤0.20; 0.01≤y/z≤0.10; and 0.5≤(x+y)/z≤1.0
c) Li_{4+y}Ti_{5-d}M²₂O₁₂ wherein M² is at least one metal selected from the group consisting of Mg, Al, Si, Ti, Zn, Zr, Ca, W, Nb, and Sn, −1≤y≤3.5, and 0≤d≤0.1
d) H₂Ti₆O₁₃
e) H₂Ti₁₂O₂₅
f) TiO₂
g) LiₓTiNb_{y}O_{z} wherein 0≤x≤5; 1≤y≤24; 7≤z≤62.
h) LiₐTiM_{b}Nb_{c}O_{7+σ} wherein 0≤a≤5; 0≤b=0.3; 0≤c=10; −0.3≤σ≤0.3 and M is at least one element selected from Fe, V, Mo and Ta.
i) Nb_{α}Ti_{β}O_{7+γ} wherein 0≤α24; 0≤β≤1; −0.3≤γ≤0.3 and mixtures thereof.

The negative electrode is prepared in a conventional manner. It consists of a conductive support used as a current collector which is coated with a layer containing the lithiated titanate oxide or the titanate oxide able to be lithiated and further comprising a binder and a conductive material. The current collector is preferably a two-dimensional conductive support such as a solid or perforated strip, generally made of copper.

The binder has the function of strengthening the cohesion between the active material particles as well as of improving the adhesion of the paste to the current collector. The binder may contain one or more of the following: polyvinylidene fluoride (PVDF) and its copolymers, polytetrafluoroethylene (PTFE), polyacrylonitrile (PAN), poly(methyl)- or (butyl)-methacrylate, polyvinyl chloride (PVC), polyvinyl formal, polyester and polyether block amides, polymers of acrylic acid, methacrylic acid, acrylamide, itaconic acid, sulfonic acid, elastomers and cellulose compounds.

The electron-conductive additive is generally selected from graphite, carbon black, acetylene black, soot or a mixture thereof. It is used in a low amount, generally 5% or less.

The positive electrochemically active material is not particularly limited.

A first preferred positive electrochemically active material is a compound ii) having the formula:
LiₓM_{2-x-y-z-w}M′_{y}M″_{z}M′″_{w}O₂ (LMO2), where:
M is Ni, M′ is Co, M″ is Al, M′″ is B or Mg, and
x ranges from 0.9 to 1.1;
y>0;
z>0;
0.1≤w≤0.2.

According to an embodiment:
x ranges from 0.9 to 1.1;
0.70≤2-x-y-z-w≤0.9
0.05≤y≤0.25;
0<z≤0.10 and
y+z+w=1.

According to an embodiment:
x ranges from 0.9 to 1.1;
0.75≤2-x-y-z-w≤0.85;
0.10≤y≤0.20;
0<z≤0.10 and
y+z+w=1.

According to an embodiment, 2-x-y-z-w=0.80; y=0.15 and z=0.05.

A second preferred positive electrochemically active material is a compound ii) having the formula:
LiₓM_{2-x-y-z-w}M′_{y}M″_{z}M′″_{w}O₂ (LMO2), where
M is Ni, M′ is Mn and M″ is Co and
M′″ is selected from the group consisting of B, Mg, Al, Si, Ca, Ti, V, Cr, Mn, Fe, Co, Ni, Cu, Zn, Y, Zr, Nb and Mo, with
0.8≤x≤1.4; 0<y≤0.5; 0<z≤0.5; 0≤w≤0.2 and x+y+z+w<2.

According to one embodiment, M is Ni, M′ is Mn, M″ is Co and 2-x-y-z-w≤0.60.

According to one embodiment, M is Ni, M′ is Mn, M″ is Co and

According to one embodiment, M is Ni, M′ is Mn, M″ is Co and 0.40≥y≤0.15; preferably 0.35≥y≤0.20.

According to one embodiment, M is Ni, M′ is Mn, M″ is Co and 0.4≥z≤0.15; preferably 0.35≥z≥0.20.

According to one embodiment, 1≤x≤1.1; preferably 1.01≤x≤1.06. Examples of compound ii) are:

LiNi_{1/3}Mn_{1/3}Co_{1/3}O₂;

Li₁₊ₓN_{0.5}Mn_{0.3}Co_{0.2}O₂ with 0.01≤x≤0.10, preferably 0.01≤x≤0.06;

Li₁₊ₓNi_{0.6}Mn_{0.2}Co_{0.2}O₂ with 0.01≤x≤0.10, preferably 0.01≤x≤0.06.

In one embodiment, Ni, Mn, and Co are partially replaced by Al (M′″=Al), such as in compound of formula LiNi_{0,3}Mn_{0,5}Co_{0,15}Al_{0,05}O₂.

A third preferred positive electrochemically active material is a compound iii) having the formula LiₓMn_{2-y-z}M′_{y}M″_{z}O₄ (LMO), where 1≤x=1.4; 0≤y≤0.6 and 0≤z≤0.2 and M′ and M″ are selected from the group consisting of B, Mg, Al, Si, Ca, Ti, V, Cr, Fe, Co, Ni, Cu, Zn, Y, Zr, Nb and Mo, M′ being different from M″.

A most preferred compound is one where x=1; 0≤y≤0.1; z=0 and M′ is Al, such as LiMn_{1.92}Al_{0.08}O₄.

The positive electrode consists of a conducting support being used as a current collector which is coated with a layer containing the positive electrochemically active material and further comprising a binder and a conductive material.

The current collector is preferably a two-dimensional conducting support such as a solid or perforated sheet, based on carbon or metal, for example in nickel, steel, stainless steel or aluminum, preferably aluminum.

The binder used in the positive electrode may be chosen from the binders disclosed in relation with the negative electrode.

The conductive material is selected from graphite, carbon black, acetylene black, soot or one of their mixtures.

Cells are produced in conventional manner. The positive electrode, a separator, and the negative electrode are superposed. The assembly is rolled up (respectively stacked) to form the electrochemical jelly roll (respectively the electrochemical stack). A connection part is bonded to the edge of the positive electrode and connected to the current output terminal. The negative electrode can be electrically connected to the can of the cell. Conversely, the positive electrode could be connected to the can and the negative electrode to an output terminal. After being inserted into the can, the electrochemical stack is impregnated in electrolyte. Thereafter the cell is closed in a leaktight manner. The can can also be provided in conventional manner with a safety valve causing the cell to open in the event of the internal gas pressure exceeding a predetermined value. The description given above is made in reference to a can having a cylindrical shape. However, the shape of the can is not limited, it can also be a prismatic shape in the case of plane electrodes.

The lithium salt can be selected from lithium perchlorate LiClO₄, lithium hexafluorophosphate Li PF₆, lithium tetrafluoroborate LiBF₄, lithium trifluoromethanesulfonate LiCF₃SO₃, lithium bis(fluorosulfonyl)imide Li(FSO₂)₂N (LiFSI), lithium trifluoromethanesulfonimide LiN(CF₃SO₂)₂ (LiTFSI), lithium trifluoromethanesulfonemethide LiC(CF₃SO₂)₃ (LiTFSM), lithium bisperfluoroethylsulfonimide LiN(C₂F₅SO₂)₂ (LiBETI), lithium 4,5-dicyano-2-(trifluoromethyl) imidazolide (LiTDI), lithium bis(oxalatoborate) (LiBOB), lithium tris(pentafluoroethyl) trifluorophosphate LiPF₃(CF₂CF₃)₃ (LiFAP) and mixtures of the foregoing.

Preferably the solvent is one or a mixture of solvents selected from conventional organic solvents, in particular saturated cyclic carbonates, unsaturated cyclic carbonates and non-cyclic carbonates, alkyl esters, such as formates, acetates, propionates or butyrates, ethers, lactones such as gamma-butyrolactone, tetrahydrothiofene dioxide, nitrile solvents, and mixtures thereof. Of the saturated cyclic carbonates, mention may be made of, for example, ethylene carbonate (EC), fluoroethylene carbonate (FEC), propylene carbonate (PC), butylene carbonate (BC), and mixtures of the above. Among the unsaturated cyclic carbonates, mention may be made of, for example, vinylene carbonate (VC), vinyl ethylene carbonate (VEC) its derivatives and mixtures thereof. Among non-cyclic carbonates, mention may, for example, be made of dimethyl carbonate (DMC), diethyl carbonate (DEC), ethyl methyl carbonate (EMC), dipropyl carbonate (DPC) and mixtures thereof. Among the alkyl esters we can for example mention methyl acetate, ethyl acetate, methyl propionate, ethyl propionate, butyl propionate, methyl butyrate, butyrate ethyl, propyl butyrate and mixtures thereof. Among the ethers we can for example mention dimethyl (DME) or diethyl (DEE) ether, and mixtures thereof.

The electrolyte can be selected from a non-aqueous liquid electrolyte comprising a lithium salt dissolved in a solvent and a solid polymer ion conducting for lithium ions electrolyte, such as polyethylene oxide (PEO).

The separator may consist of a layer of polypropylene (PP), polyethylene (PE), polytetrafluoroethylene (PTFE), polyacrylonitrile (PAN), polyethylene terephthalate (PET), cellulose or of a mixture of layers of different natures. The cited polymers can be coated with a ceramic layer and/or with polyvinylidene difluoride (PVdF) or poly(vinylidene fluoride-hexafluoropropylene (PVdF-HFP) .

One advantage of the cell according to the invention is that it may be charged at high rates. Typical high charge rates range from 0.5C to 7C. The cell may be charged at a charge rate of at least C, at least 2C, at least 3C or at least 5C.

Further, the cell may be discharged at high rates but it still provides a high Ampere-hour capacity despite this high discharge rate. Typical high discharge rates range from 0.5C to 7C. The cell may be discharged at a discharge rate of at least C, at least 2C, at least 3C and at least 5C. The invention present another advantage than that of extending the lifetime of the cell or allowing to reach higher depths of discharge. By increasing the energy density of the cell, it is possible to lower the weight of the electrochemical cell and consequently, the weight of the satellite.

The cell according to the invention is used in a satellite operated in low earth orbit. The use of this cell avoids the development of heterogeneity of the lithium distribution at the negative electrode thanks to the presence of a lithiated titanate oxide (or a titanate oxide able to be lithiated). Indeed, in a conventional cell equipping a satellite placed in low earth orbit and which contains graphite as the negative electrochemically active material, one observes heterogeneity of the lithium distribution at the negative electrode when it is charged at a high current. In such a situation where there is no rest period between the charge and the discharge, homogenization of the lithium distribution cannot occur and the heterogeneity of the lithium distribution remains at the negative electrode. The cell according to the invention solves this problem through the use of a lithiated titanate oxide (or a titanate oxide able to be lithiated) in the negative electrode. The cell according to the invention can withstand a series of charges/discharges at a high current even in the absence of any rest period between charge and discharge.

The cell prepared according to the invention may be used in particular in a communication satellite or an Earth or space observation satellite.

The invention is of less interest when the cell is to be used in satellites placed in a geostationary orbit, that is, an orbit located at an altitude of 36,000 km above the Earth's equator. Indeed, a satellite placed in a geostationary orbit follows the direction of the earth's rotation. Its orbital period is thus equal to the Earth's rotational period (24 hours). Therefore, the cell it contains does not undergo about 15 charge/discharge cycles in a day. It can be charged at a lower current, in which case, the problem of the heterogeneity of lithium distribution does not occur.

### EXAMPLES

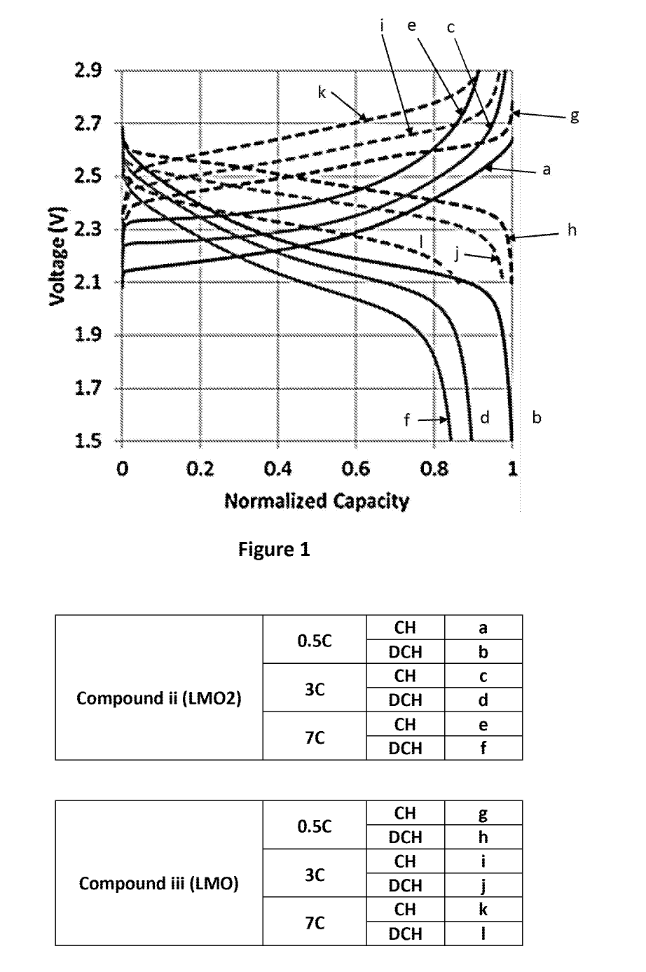

A) The following example illustrates the good charging capability and the good discharging capability of the cell according to the invention. Two cells were prepared. The positive electrochemically active material of the first cell is a type ii) compound (LMO2) comprising nickel, manganese and cobalt. The positive electrochemically active material of the second cell is a type iii) compound (LMO). The negative electrochemically active material in both cells is a lithiated titanate oxide (LTO). Each cell has undergone a charge followed by a discharge. Charge and discharge were performed at the three following rates: 0.5C, 3C and 7C. FIG. 1 shows the charge and discharge curves at these various rates.

As far as the charging ability is concerned, it is worth noting from FIG. 1 that the cell according to the invention can be charged at a high charge rate. This is evidenced by the shape of the charge curves which show that the inclined plateaus extend up to about 90% of the cell nominal capacity. This indicates that the cell can be charged up to about 90% of its nominal capacity before the polarization phenomenon occurs. When the cell is charged beyond about 90% of its capacity, the polarization phenomenon occurs and the charge curves exhibit a steep upward slope.

The table below indicates the Ampere-hour capacity provided by the cell at various high discharge rates.

| | Discharge | Capacity supplied by the cell with |
|---|---|---|
| Discharge rate | duration | respect to the nominal capacity C of the cell |
| 0.5 C | 2 h | 97-100% |
| 3 C | 20 min | 90-97% |
| 7 C | 8 min | 80-90% |

It is worth noting that even at the discharge rates 3C and 7C, the capacity supplied by the cell remains high, that is, at least 80%.

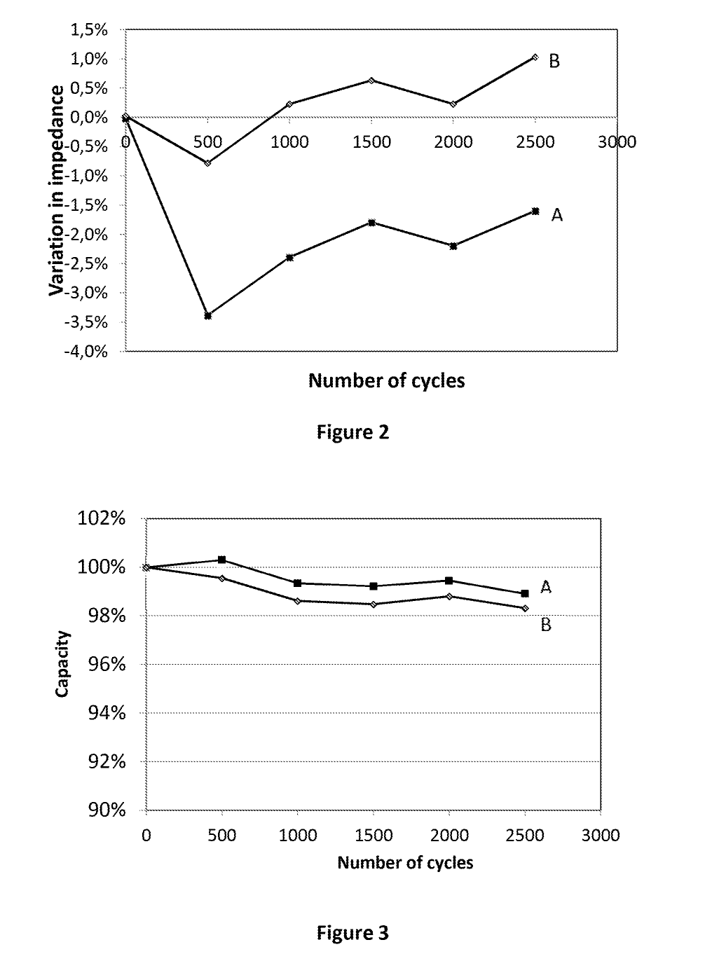

B) Two cells A-B according to the invention were prepared. In both cells, the positive electrochemically active material is a lithiated oxide of nickel, cobalt and aluminum (NCA). The negative electrochemically active material is a lithiated titanate oxide (LTO). The operating of the cell in a low earth orbit application was simulated by subjecting the cell to cycles of charge/discharge. The charge was performed at a C rate. The discharge was performed at a 2C rate and down to a depth of discharge of 80%. The impedance of cells A and B was measured at every 500 cycles by subjecting the cell to a C/2 discharge rate. The variation of impedance as a function of the number of cycles is shown on FiG. 2. FIG. 2 shows that the variation in impedance remains limited during the first 2,500 cycles. Indeed, it is 5% or less for both cells. The capacity of cells A and B was measured at every 500 cycles by subjecting the cell to a C/2 discharge rate. The variation of capacity as a function of the number of cycles is shown on FIG. 3. FIG. 3 shows that capacity loss remains very limited during the first 2,500 cycles, since it is 2% or less.

C) Two groups of cells were prepared. The first group comprises one cell, cell C, which is a reference cell. Its negative electrode contains graphite as an electrochemically active material. The second group comprises eight cells, namely cells D-K, the negative electrode of which contains a lithiated titanate oxide as electrochemically active material: Cells D-K are according to the invention.

Cells C-K were tested under conditions which simulate the operating of a cell placed in low Earth orbit. The following charge/discharge rates were applied:

a charge current of C/6 when the depth of discharge is 15%;

a charge current of C/5 when the depth of discharge is 20%;

a charge current of C/3 when the depth of discharge is 30%.

The discharge current was:

C/4 when the depth of discharge is 15%;

C/3 when the depth of discharge is 20%;

C/2 when the depth of discharge is 30%.

The table below shows for each cell, the depth of discharge down to which it is discharged, the temperature at which the cell operates and the charging cut-off voltage.

| | Depth of discharge | Temperature | Charging cut-off voltage |
|---|---|---|---|
| Cell | (%) | (° C.) | (V) |
| C | 15 | 20 | 4.10 |
| D | 30 | 20 | 4.05 |
| E | 20 | 30 | 4.05 |
| F | 20 | 20 | 4.05 |
| G | 20 | 20 | 4.00 |
| H | 15 | 20 | 3.85 |
| I | 15 | 20 | 3.95 |
| J | 20 | 20 | 3.90 |
| K | 15 | 20 | 4.05 |

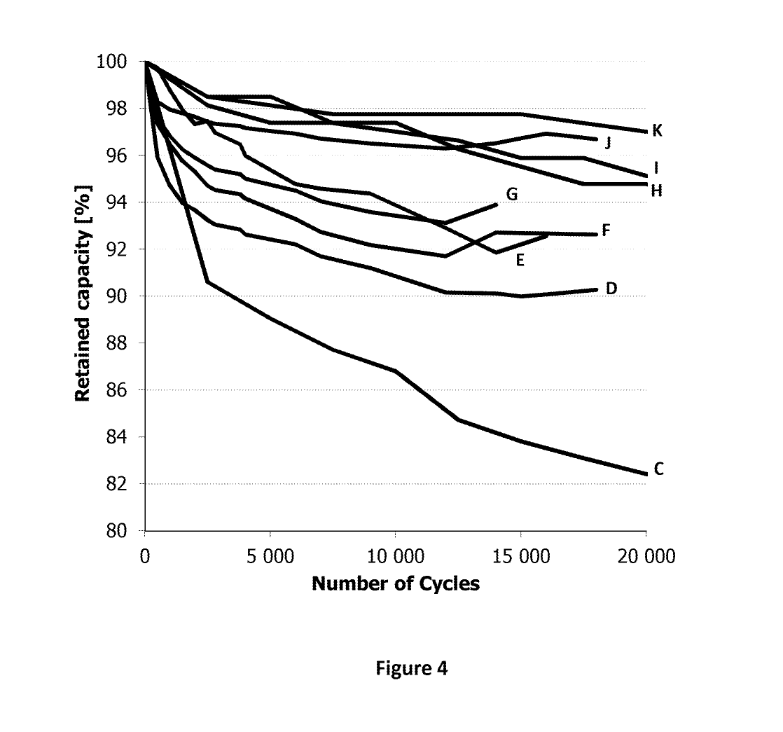

FIG. 4 shows the percentage of retained capacity as a function of the number of cycles for a reference cell (C) and for cells according to the invention (D-K). It shows that cell C, which serves as a reference, exhibits a capacity loss of 18% after 20,000 cycles. In comparison, cells H, I and K, which were cycled under the same conditions exhibit a capacity loss of less than 6%.

Additionally, FIG. 4 shows with cells D, E, F, G and J, that these cells may be cycled at a higher depth of discharge than cell C but still exhibit a lower capacity loss. Indeed, cells D, E, F, G and J were cycled at a depth of discharge of 20 or 30%, thus higher than 15%, but they still exhibit a capacity loss of 10% or less after 15,000 cycles, which is lower than the capacity loss of 16% after 15,000 cycles obtained with cell C.

These results thus show that a cell having a negative electrode comprising a lithiated titanate oxide is less subject to capacity loss than a cell containing graphite having a negative electrode comprising graphite. It is to be noted that the charge-cut off voltage has little influence on the cell cycling ability. Although, the cut-off voltage is varied in the examples, it is not responsible for the significant increase of the life cycle in the cells according to the invention.

1-12. (canceled)

13. An electrochemical cell for a low earth orbit spacecraft, said electrochemical cell comprising a positive electrode and a negative electrode, said negative electrode comprising as an electrochemically active material a lithiated titanate oxide or a titanate oxide able to be lithiated.

14. The electrochemical cell according to claim 13, wherein the electrochemical cell is configured to be discharged at a depth of discharge of at least 50%

15. The electrochemical cell according to claim 14, wherein the electrochemical cell is configured to be discharged at a depth of discharge of at least 70%.

16. The electrochemical cell according to claim 15, wherein the electrochemical cell is configured to be discharged at a depth of discharge of at least 80%.

17. The electrochemical cell according to claim 13, wherein the electrochemical cell is configured to be charged at a current of at least C/2, wherein C is the nominal capacity of the electrochemical cell.

18. The electrochemical cell according to claim 17, wherein the electrochemical cell is configured to be charged at a current of at least C.

19. The electrochemical cell according to claim 13, wherein the electrochemical cell is configured to undergo at least 15 cycles of charge/discharge per day.

20. The electrochemical cell according to claim 13, wherein the lifetime of the electrochemical cell is up to 12 years.

21. The electrochemical cell according to claim 19, wherein the electrochemical cell is configured to undergo at least about 65,000 cycles during its lifetime.

22. The electrochemical cell according to claim 21, wherein the electrochemical cell is configured to undergo at least 70,000 cycles

23. The electrochemical cell according to claim 13, wherein the lithiated titanate oxide or the titanate oxide able to be lithiated is selected from the group consisting of:
a) LiₐTi_{b}O₄ wherein 0.5≤a≤3 and 1≤b≤2.5
b) LiₓMg_{y}Ti_{z}O₄ wherein x>0; z>0; 0.01≤y≤0.20; 0.01≤y/z≤0.10 and
0.5≤(x+y)/z≤1.0
c) Li_{4+y}Ti_{5-d}M²_{d}O₁₂ wherein M² is at least one metal selected from the group consisting of Mg, Al, Si, Ti, Zn, Zr, Ca, W, Nb, and Sn, −1≤y≤3.5 and 0≤d≤0.1
d) H₂Ti₆O₁₃
e) H₂Ti₁₂O₂₅
f) TiO₂
g) LiₓTiNb_{y}O_{z} wherein 0≤x≤5; 1≤y≤24; 7≤z≤62
h) LiₐTiM_{b}Nb_{c}O_{7+σ} wherein 0≤a≤5; 0≤b≤0.3; 0≤c≤10; −0.3≤σ≤0.3 and M is at least one element selected from Fe, V, Mo and Ta
i) Nb_{α}Ti_{β}O_{7+γ} wherein 0≤α≤24; 0≤1; −0.3≤γ≤0.3
and mixtures thereof.

24. The electrochemical cell according to claim 13, wherein the positive electrode comprises an electrochemically active material selected from the group consisting of:
compound i) having the formula LiₓMn_{1-y-z}M′_{y}M″_{z}PO₄ (LMP), where M′ and M″ are different from one another and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
compound ii) having the formula LiₓM_{2-x-y-z-w}M′_{y}M″_{z}M′″_{w}O₂ (LMO2), where M, M′, M″ and M′″ are selected from the group consisting of B, Mg, Al, Si, Ca, Ti, V, Cr, Mn, Fe, Co, Ni, Cu, Zn, Y, Zr, Nb and Mo, provided that M or M′ or M″ or M′″ is selected from Mn, Co, Ni, or Fe;
M, M′, M″ and M′″ being different from each other; with 0.8≤x≤1.4;
0≤y≤0.5; 0≤z≤0.5; 0≤w≤0.2 and x+y+z+w<2;
compound iii) having the formula LiₓMn_{2-y-z}M′_{y}M″_{z}O₄ (LMO), where M′ and M″ are selected from the group consisting of B, Mg, Al, Si, Ca, Ti, V, Cr, Fe, Co, Ni, Cu, Zn, Y, Zr, Nb and Mo; M′ and M″ are different from each other, and 1≤x≤1.4; 0≤y≤0.6; 0≤z≤0.2;
compound iv) of formula LiₓFe_{1-y}M_{y}PO₄(LFMP), where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6;
compound v) of formula xLi₂MnO₃; (1-x)LiMO₂ where M is selected from Ni, Co and Mn and x≤1;
compound vi) of formula L_{a+y}(M¹₍₁₋ₜ₎Moₜ)₂M²_{b}(O₁₋ₓF₂ₓ)_{c} wherein M¹ is selected from the group consisting of Ni, Mn, Co, Fe, V or a mixture thereof; M² is selected from the group consisting of B, Al, Si, P, Ti and Mo;
with 4≤a≤6; 0≤b≤1.8; 3.8≤c≤14; 0≤x<1; −0.5≤y≤0.5; 0≤t≤0.9; b/a<0.45
the coefficient c satisfying one of the following relationships:
c=4+y/2+z+2t+1.5b if M² is selected from B and Al;
c=4+y/2+z+2t+2b if M² is selected from Si, Ti and Mo;
c=4+y/2+z+2t+2.5b if M² is P;
with z=0 if M¹ is selected from Ni, Mn, Co and Fe; and z=1 if M¹ is V.
compound vii) of formula Li₄₊ₓMnM¹ₐM²_{b}O_{c} wherein:
M¹ is selected from the group consisting in Ni, Mn, Co, Fe and a mixture thereof;
M² is selected from the group consisting in Si, Ti, Mo, B, Al and a mixture thereof; with:
−1.2≤x≤3; 0<a≤2.5; 0≤b≤1.5; 4.3≤c=10; and
c=4+a+n.b+x/2
wherein:
n=2 when M² is selected from the group consisting in Si, Ti, Mo or a mixture thereof; and
n=1.5 when M² is selected from the group consisting in B, Al or a mixture thereof,
and a mixture of one or more of compounds i) to vii).

25. The electrochemical cell according to claim 24, wherein in compound ii);
1≤x≤1.15;
M is Ni;
M′ is Co;
M″ is Al
y>0;
z>0;
w=0.

26. The electrochemical cell according to claim 25, wherein x=1; 0.6≤2-x-y-z≤0.85; 0.10≤y≤0.25; 0.05≤z≤0.15.

27. The electrochemical cell according to claim 26, wherein compound ii) is LiNi_{0,8}Co_{0,15}Al_{0,05}O₂.

28. The electrochemical cell according to claim 13, wherein the spacecraft is a satellite.

29. A method comprising the step of charging or discharging an electrochemical cell in a low earth orbit spacecraft, said electrochemical cell comprising a positive electrode and a negative electrode, said negative electrode comprising as an electrochemically active material a lithiated titanate oxide or a titanate oxide able to be lithiated.

30. The method according to claim 29, wherein the electrochemical cell is discharged at a depth of discharge of at least 50%.

31. The method according to claim 30, wherein the electrochemical cell is discharged at a depth of discharge of at least 70%.

32. The method according to claim 31, wherein the electrochemical cell is discharged at a depth of discharge of at least 80%.

33. The method according to claim 32, wherein the electrochemical cell is charged at a current of at least C/2, wherein C is the nominal capacity of the electrochemical cell.

34. The method according to claim 33, wherein the electrochemical cell is charged at a current of at least C.

35. The method according to claim 29, wherein the electrochemical cell undergoes at least 15 cycles of charge/discharge per day.

36. The method according to claim 29, wherein the lifetime of the electrochemical cell is up to 12 years.

37. The method according to claim 35, wherein the electrochemical cell is undergoes at least about 65,000 cycles during its lifetime.
